(19) United States
(12) Patent Application Publication
(10) Pub. No.: US 2013/0288037 A1
(43) Pub. Date: Oct. 31, 2013

(54) PLASMA SPRAY COATING PROCESS ENHANCEMENT FOR CRITICAL CHAMBER COMPONENTS

(71) Applicant: APPLIED MATERIALS, INC., Santa Clara, CA (US)

(72) Inventors: Jennifer Y. Sun, Mountain View, CA (US); Biraja P. Kanungo, San Jose, CA (US); Ren-Guan Duan, Fremont, CA (US); Benjamin Schwarz, San Jose, CA (US)

(73) Assignee: APPLIED MATERIALS, INC., Santa Clara, CA (US)

(21) Appl. No.: 13/749,600

(22) Filed: Jan. 24, 2013

Related U.S. Application Data
(60) Provisional application No. 61/639,775, filed on Apr. 27, 2012.

(51) Int. Cl. C04B 35/505; C04B 35/628

(52) U.S. Cl. CPC C04B 35/505; C04B 35/62884
USPC 428/312.8; 427/453; 423/263

(57) ABSTRACT

In an optimized method to apply a plasma sprayed coating of a yttrium containing oxide onto an article, a plasma power of between about 89-91 kW is selected for a plasma spraying system. Gas is flowed through the plasma spraying system at a selected gas flow rate of about 115-130 L/min. Ceramic powder comprising a yttrium containing oxide is fed into the plasma spraying system at a selected powder feed rate of about 10-30 g/min. A yttrium dominant ceramic coating is then formed on the article based on the selected power, the selected gas flow rate and the selected powder feed rate.

### RELATED APPLICATIONS

This patent application claims the benefit under 35 U.S.C. §119(e) of U.S. Provisional Application No. 61/639,775, filed Apr. 27, 2012.

### TECHNICAL FIELD

Embodiments of the present disclosure relate, in general, to ceramic coated articles and to a process for applying a ceramic coating to substrates.

### BACKGROUND

In the semiconductor industry, devices are fabricated by a number of manufacturing processes producing structures of an ever-decreasing size. Some manufacturing processes such as plasma etch and plasma clean processes expose a substrate to a high-speed stream of plasma to etch or clean the substrate. The plasma may be highly corrosive, and may corrode processing chambers and other surfaces that are exposed to the plasma. This corrosion may generate particles, which frequently contaminate the substrate that is being processed, contributing to device defects.

As device geometries shrink, susceptibility to defects increases, and particle contaminant requirements become more stringent. Accordingly, as device geometries shrink, allowable levels of particle contamination may be reduced. To minimize particle contamination introduced by plasma etch and/or plasma clean processes, chamber materials have been developed that are resistant to plasmas. Different materials provide different material properties, such as plasma resistance, rigidity, flexural strength, thermal shock resistance, and so on. Also, different materials have different material costs. Accordingly, some materials have superior plasma resistance, other materials have lower costs, and still other materials have superior flexural strength and/or thermal shock resistance.

### SUMMARY

In one embodiment, a ceramic coated article includes a substrate and a ceramic plasma spray coating on the substrate. To manufacture the ceramic coated article, a plasma gun power, powder feed rate, and carrier gas is determined, and the conductive substrate is plasma spray coated with a ceramic coating.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates an exemplary architecture of a manufacturing system, in accordance with one embodiment of the present invention;

FIG. 2 illustrates one embodiment of a system for performing plasma etch on a substrate;

FIG. 3 illustrates a system for plasma spraying a coating on a dielectric etch component, or other article used in a corrosive system;

FIG. 4 is a flow chart showing a process for manufacturing a coated article, in accordance with embodiments of the present disclosure.

FIG. 5 shows a pair of micrographs of a sample of a ceramic coated article, in accordance with embodiments of the present invention;

FIG. 6 illustrates cross-sectional side views of ceramic coatings that have been created using various plasma spray parameters;

FIG. 7 illustrates additional cross-sectional side views of ceramic coatings that have been created using various plasma spray parameters;

FIG. 8 illustrates top view micrographs of a ceramic coating;

FIG. 9 illustrates additional top view micrographs of a ceramic coating;

FIG. 10 illustrates micrographs of a top view of ceramic coatings manufactured using different coating angles and feed rates;

FIG. 11 illustrates cross-section micrographs of a ceramic coating using various input parameters; and

FIG. 12 illustrates cross-section micrographs of a ceramic coating using various input parameters.

### DETAILED DESCRIPTION OF EMBODIMENTS

Embodiments of the disclosure are directed to a process for coating an article with a ceramic coating. In one embodiment, the article is roughened, and then coated with a ceramic coating. Parameters for the roughening and the coating may be optimized to maximize an adhesion strength of the ceramic coating to the substrate, and thus to reduce future delamination of the ceramic coating from the article. Optimization of a plasma spray process may include optimization of a plasma power (byproduct of voltage and current), a primary and secondary gas flow rate, powder size and a powder material composition and/or powder feed rate. Other optimized parameters may include a gun distance, a gun moving speed, a gun moving pitch, and so on.

The ceramic coating of the article may be highly resistant to plasma etching, and the substrate may have superior mechanical properties such as a high flexural strength and a high thermal shock resistance. Performance properties of the coated ceramic article may include a relatively high thermal capability, a relatively long lifespan, and a low on-wafer particle and metal contamination.

When the terms “about” and “approximately” are used herein, these are intended to mean that the nominal value presented is precise within ±10%. The articles described herein may be structures that are exposed to plasma, such as chamber components for a plasma etcher (also known as a plasma etch reactor). For example, the articles may be walls, bases, gas distribution plates, shower heads, substrate holding frames, etc. of a plasma etcher, a plasma cleaner, a plasma propulsion system, and so forth.

Moreover, embodiments are described herein with reference to ceramic coated articles that may cause reduced particle contamination when used in a process chamber for plasma rich processes. However, it should be understood that the ceramic coated articles discussed herein may also provide reduced particle contamination when used in process chambers for other processes such as non-plasma etchers, non-plasma cleaners, chemical vapor deposition (CVD) chamber, physical vapor deposition (PVD) chamber, and so forth. Moreover, some embodiments are described with reference to a high performance material (HPM) ceramic coating (described below). However, it should be understood that embodiments equally apply to other plasma resistant ceramics (e.g., other yttrium containing ceramics).

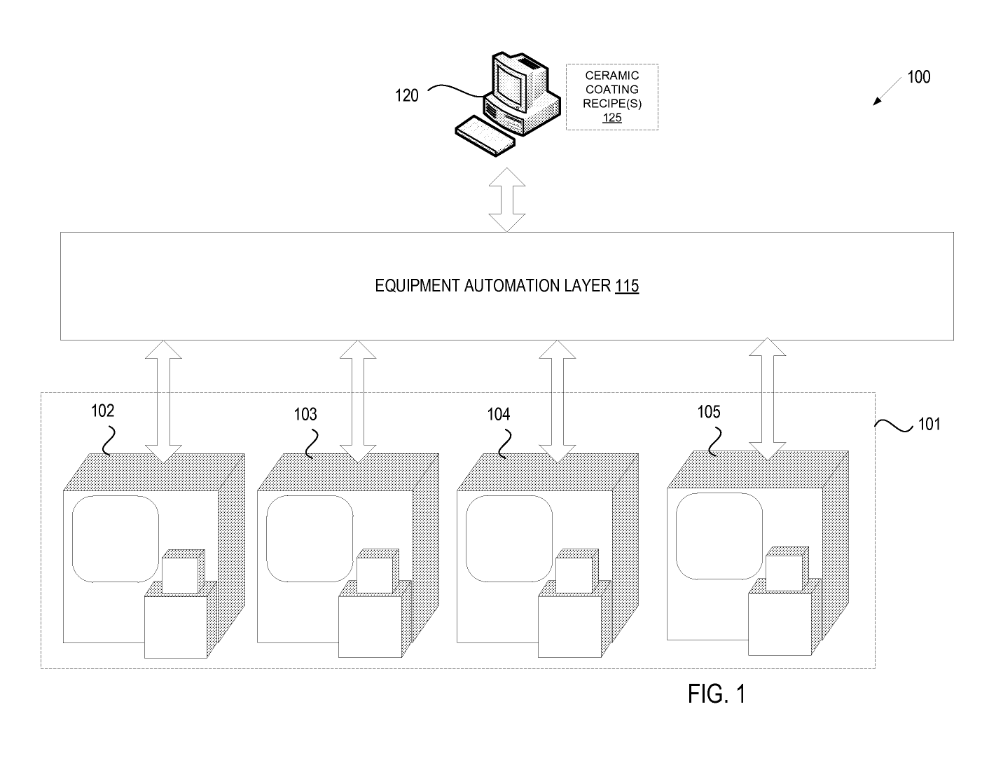

FIG. 1 illustrates an exemplary architecture of a manufacturing system 100. The manufacturing system 100 may be a ceramics manufacturing system. In one embodiment, the manufacturing system 100 includes processing equipment 101 connected to an equipment automation layer 115. The processing equipment 101 may include a bead blaster 102, one or more wet cleaners 103, a ceramic coater 104 and/or one or more grinders 105. The manufacturing system 100 may further include one or more computing device 120 connected to the equipment automation layer 115. In alternative embodiments, the manufacturing system 100 may include more or fewer components. For example, the manufacturing system 100 may include manually operated (e.g., off-line) processing equipment 101 without the equipment automation layer 115 or the computing device 120.

Bead blaster 102 is a machine configured to roughen the surface of articles such as articles. Bead blaster 102 may be a bead blasting cabinet, a hand held bead blaster, or other type of bead blaster. Bead blaster 102 may roughen a substrate by bombarding the substrate with beads or particles. In one embodiment, bead blaster 102 fires ceramic beads or particles at the substrate. The roughness achieved by the bead blaster 102 may be based on a force used to fire the beads, bead materials, bead sizes, distance of the bead blaster from the substrate, processing duration, and so forth. In one embodiment, the bead blaster uses a range of bead sizes to roughen the ceramic article.

In alternative embodiments, other types of surface rougheners than a bead blaster 102 may be used. For example, a motorized abrasive pad may be used to roughen the surface of ceramic substrates. A sander may rotate or vibrate the abrasive pad while the abrasive pad is pressed against a surface of the article. A roughness achieved by the abrasive pad may depend on an applied pressure, on a vibration or rotation rate and/or on a roughness of the abrasive pad.

Wet cleaners 103 are cleaning apparatuses that clean articles (e.g., articles) using a wet clean process. Wet cleaners 103 include wet baths filled with liquids, in which the substrate is immersed to clean the substrate. Wet cleaners 103 may agitate the wet bath using ultrasonic waves during cleaning to improve a cleaning efficacy. This is referred to herein as sonicating the wet bath.

In other embodiments, alternative types of cleaners such as dry cleaners may be used to clean the articles. Dry cleaners may clean articles by applying heat, by applying gas, by applying plasma, and so forth.

Ceramic coater 104 is a machine configured to apply a ceramic coating to the surface of a substrate. In one embodiment, ceramic coater 104 is a plasma sprayer that plasma sprays a ceramic coating onto the ceramic substrate. In alternative embodiments, the ceramic coater 104 may apply other thermal spraying techniques such as detonation spraying, wire arc spraying, high velocity oxygen fuel (HVOF) spraying, flame spraying, warm spraying and cold spraying may be used. Additionally, ceramic coater 104 may perform other coating processes such as aerosol deposition, electroplating, physical vapor deposition (PVD) and chemical vapor deposition (CVD) may be used to form the ceramic coating.

Grinders 105 are machines having an abrasive disk that grinds and/or polishes a surface of the article. The grinders 105 may include a polishing/grinding system such as a rough lapping station, a chemical mechanical planarization (CMP) device, and so forth. The grinders 105 may include a platen that holds a substrate and an abrasive disk or polishing pad that is pressed against the substrate while being rotated.

These grinders 105 grind a surface of the ceramic coating to decrease a roughness of the ceramic coating and/or to reduce a thickness of the ceramic coating. The grinders 105 may grind/polish the ceramic coating in multiple steps, where each step uses an abrasive pad with a slightly different roughness and/or a different slurry (e.g., if CMP is used). For example, a first abrasive pad with a high roughness may be used to quickly grind down the ceramic coating to a desired thickness, and a second abrasive pad with a low roughness may be used to polish the ceramic coating to a desired roughness.

The equipment automation layer 115 may interconnect some or all of the manufacturing machines 101 with computing devices 120, with other manufacturing machines, with metrology tools and/or other devices. The equipment automation layer 115 may include a network (e.g., a location area network (LAN)), routers, gateways, servers, data stores, and so on. Manufacturing machines 101 may connect to the equipment automation layer 115 via a SEMI Equipment Communications Standard/Generic Equipment Model (SECS/GEM) interface, via an Ethernet interface, and/or via other interfaces. In one embodiment, the equipment automation layer 115 enables process data (e.g., data collected by manufacturing machines 101 during a process run) to be stored in a data store (not shown). In an alternative embodiment, the computing device 120 connects directly to one or more of the manufacturing machines 101.

In one embodiment, some or all manufacturing machines 101 include a programmable controller that can load, store and execute process recipes. The programmable controller may control temperature settings, gas and/or vacuum settings, time settings, etc. of manufacturing machines 101. The programmable controller may include a main memory (e.g., read-only memory (ROM), flash memory, dynamic random access memory (DRAM), static random access memory (SRAM), etc.), and/or a secondary memory (e.g., a data storage device such as a disk drive). The main memory and/or secondary memory may store instructions for performing heat treatment processes described herein.

The programmable controller may also include a processing device coupled to the main memory and/or secondary memory (e.g., via a bus) to execute the instructions. The processing device may be a general-purpose processing device such as a microprocessor, central processing unit, or the like. The processing device may also be a special-purpose processing device such as an application specific integrated circuit (ASIC), a field programmable gate array (FPGA), a digital signal processor (DSP), network processor, or the like. In one embodiment, programmable controller is a programmable logic controller (PLC).

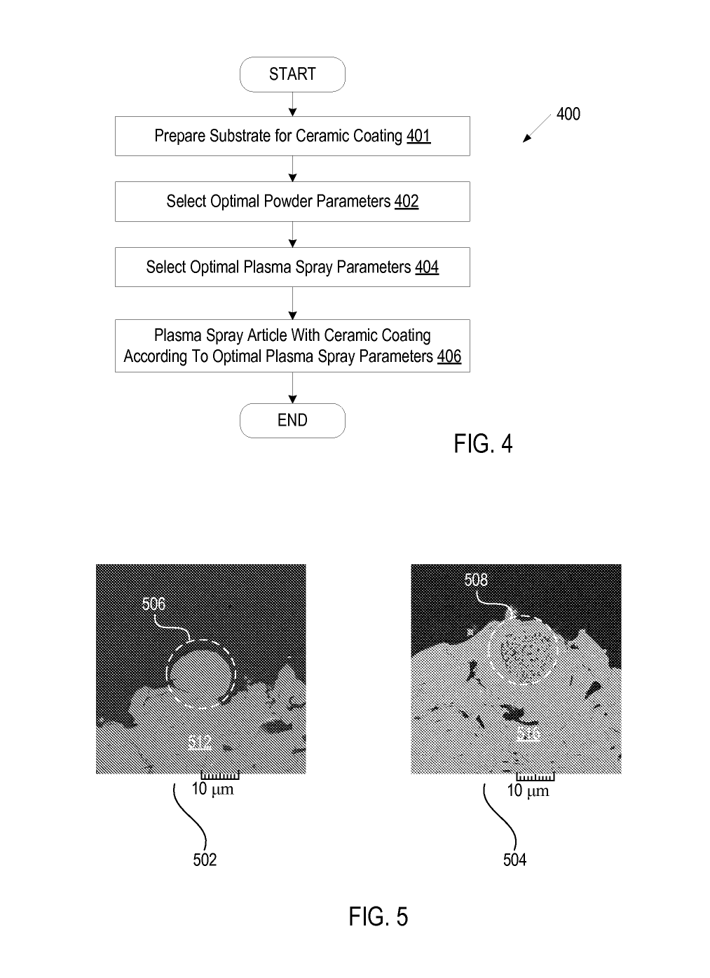

In one embodiment, the manufacturing machines 101 are programmed to execute recipes that will cause the manufacturing machines to roughen a substrate, clean a substrate and/or article, coat a article and/or machine (e.g., grind or polish) a article. In one embodiment, the manufacturing machines 101 are programmed to execute recipes that perform operations of a multi-step process for manufacturing a ceramic coated article, as described with reference to FIG. 4. The computing device 120 may store one or more ceramic coating recipes 125 that can be downloaded to the manufacturing machines 101 to cause the manufacturing machines 101 to manufacture ceramic coated articles in accordance with embodiments of the present disclosure.

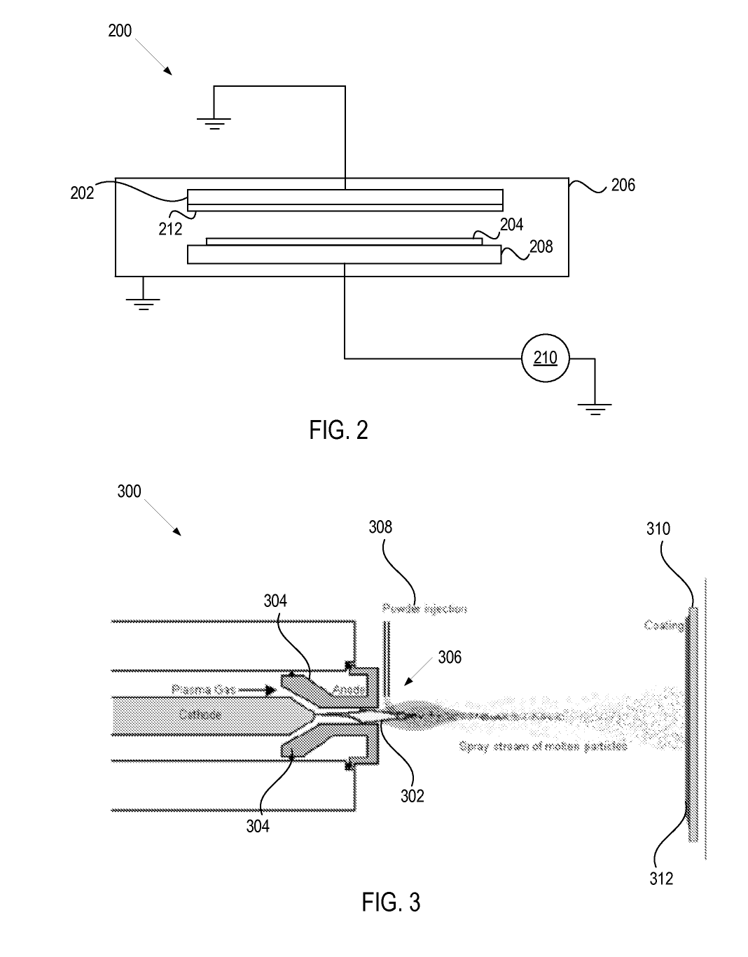

FIG. 2 is a schematic block diagram illustrating one embodiment of a system 200 for performing plasma etch on a substrate 204. The system 200, in one embodiment, is a dielectric etch system such as a Reactive Ion Etch (RIE), an Inductively Coupled Plasma (ICP), or a Plasma Etch system that utilizes a parallel plate configuration. The system 200 implements a chemically reactive plasma to remove material deposited on the substrate 204 or wafer. The system can also be conductor etch system. Usually dielectric etch systems are capacitive coupled plasma (CCP) and the conductor etch systems are inductive couple plasma (ICP).

The system 200 comprises a vacuum chamber 206 with a substrate 204 positioned below a showerhead 202. The showerhead 202 functions as an electrode that, together with the lower electrode 208, create an electric field that accelerates ions from a gas towards the surface of the substrate 204. The gas enters the system 200 through inlets formed in the showerhead 202. The types and amounts of gas depend upon the etch process, and the ion plasma may be generated from the gas with an RF powered magnetic field driven by an RF signal generator 210.

The ions and electrons, because of a large voltage difference between the showerhead 202 and the electrode 208, drift towards the substrate 204 and electrode 208 where they collide with the substrate 204, which causes the substrate 204 to be etched. The ions react chemically with the substrate 204. However, due to the velocity of the ions, some ions rebound towards the various components of the system 200 and, over the course of time, can react with and corrode the various components. Accordingly, in one embodiment, the various components may be covered by a ceramic coating 212 (given by way of example as a coating on the showerhead) to protect and prolong the useful life of the components. The ceramic coating may additionally block the formation of AlF and/or other reactants for plasma etch processes (e.g., those that use fluorine gas).

The coating 212 may be formed from a plasma sprayed ceramic such as Y₂O₃ (yttria or yttrium oxide), Y₄Al₂O₉ (YAM), Al₂O₃ (alumina), Y₃Al₅O₁₂ (YAG), Quartz, SiC (silicon carbide) Si₃N₄ (silicon nitride), SiN (silicon nitride), AlN (aluminum nitride), TiO₂ (titania), ZrO₂ (zirconia), TiC (titanium carbide), ZrC (zirconium carbide), TiN (titanium nitride), Y₂O₃ stabilized ZrO₂ (YSZ), and so on. The coating 212 may also be a ceramic composite such as AG-1000 (an Al₂O₃—YAG solid solution) or a SiC—Si₃N₄ solid solution. The coating 212, in another embodiment, is a High Performance Material (HPM) coating over the article 202. For example, the HPM coating may be composed of a compound Y₄Al₂O₉ (YAM) and a solid solution Y₂-xZrₓO₃ (Y₂O₃—ZrO₂ solid solution). Note that pure yttrium oxide as well as yttrium oxide containing solid solutions may be doped with one or more of ZrO₂, Al₂O₃, SiO₂, B₂O₃, Er₂O₃, Nd₂O₃, Nb₂O₅, CeO₂, Sm₂O₃, Yb₂O₃, or other oxides. Note that though the ceramic coating is shown on the showerhead 202, other components of the system 200 may include a ceramic coating instead of or in addition to the showerhead 202.

The ceramic coating 212 may be produced from a ceramic powder or a mixture of ceramic powders. For example, a yttria coating may be produced from the yttria powder. Similarly, the HPM ceramic composite may be produced from a mixture of a Y₂O₃ powder, a ZrO₂ powder and an Al₂O₃ powder. In one embodiment, the HPM ceramic composite contains 77 wt % Y₂O₃, 15 wt % ZrO₂ and 8 wt % Al₂O₃. In another embodiment, the HPM ceramic composite contains 63 wt % Y₂O₃, 23 wt % ZrO₂ and 14 wt % Al₂O₃. In still another embodiment, the HPM ceramic composite contains 55 wt % Y₂O₃, 20 wt % ZrO₂ and 25 wt % Al₂O₃. Relative percentages may be in molar and atomic ratios. For example, the HPM ceramic composite may contain 63 mol % Y₂O₃, 23 mol % ZrO₂ and 14 mol % Al₂O₃. Other distributions of these ceramic powders may also be used for the HPM material.

The ceramic coating 212 may enable higher thermal dielectric etching by allowing an operating temperature in the range of between about 120 and 180 degrees Celsius. Also, the ceramic coating 212 allows for longer working lifetimes due to the plasma resistance of the ceramic coating 212 and decreased on-wafer or substrate contamination. Beneficially, in some embodiments the ceramic coating 212 may be stripped and re-coated without affecting the dimensions of the substrates that are coated.

FIG. 3 illustrates a system 300 for plasma spraying a coating on a dielectric etch component, or other article used in a corrosive system. The system 300 is a type of thermal spray system. In a plasma spray system 300, an arc 302 is formed between two electrodes 304 through which a gas is flowing. Examples of gas suitable for use in the plasma spray system 300 include, but are not limited to, Argon/Hydrogen or Argon/Helium. As the gas is heated by the arc 302, the gas expands and is accelerated through the shaped nozzle 306, creating a high velocity plasma stream.

Powder 308 is injected into the plasma spray or torch where the intense temperature melts the powder and propels the material towards the article 310. Upon impacting with the article 310, the molten powder flattens, rapidly solidifies, and forms a ceramic coating 312. The molten powder adheres to the article 310. The parameters that affect the thickness, density, and roughness of the ceramic coating 312 include type of powder, powder size distribution, powder feed rate, plasma gas composition, gas flow rate, energy input, torch offset distance, and substrate cooling. A plasma spray process with optimized parameters is discussed in greater detail below.

FIG. 4 is a flow chart showing a process 400 for manufacturing a coated article, in accordance with embodiments of the present disclosure. The steps of process 400 will be described with reference to coating of an article or substrate as described above, which may be used in a reactive ion etch or plasma etch system.

At block 401, a substrate is prepared for coating. The substrate may be a metal substrate such as aluminum, copper, magnesium, or another metal or a metal alloy. The substrate may also be a ceramic substrate, such as alumina, yttria, or another ceramic or a mixture of ceramics. Preparing the substrate may include shaping the substrate to a desired form, grinding, blasting or polishing the substrate to provide a particular surface roughness and/or cleaning the substrate.

At block 402, optimal powder characteristics for plasma spraying a ceramic coating are selected. In one embodiment, an optimal powder type and an optimal powder size distribution are selected for the powder. In one embodiment, the powder type may be selected to produce an HPM coating. For example, the powder type may include varying molar percentages of Y₂O₃, ZrO₂ and Al₂O₃. In one embodiment, an optimized agglomerate powder size distribution is selected where 10% of agglomerate powder (D10) has a size of less than 10 μm, 50% of agglomerate powder (D50) has a size of 20-30 μm and 90% of agglomerate powder (D90) has a size of less than 55 μm. In another embodiment, the powder type may be selected to produce a yttria coating.

Raw ceramic powders having specified compositions, purity and particle sizes are selected. The ceramic powder may be formed of Y₂O₃, Y₄Al₂O₉, Y₃Al₅O₁₂ (YAG), or other yttria containing ceramics. Additionally, ceramic powder may be doped with one or more of ZrO₂, Al₂O₃, SiO₂, B₂O₃, Er₂O₃, Nd₂O₃, Nb₂O₅, CeO₂, Sm₂O₃, Yb₂O₃, or other oxides.

The raw ceramic powders are then mixed. In one embodiment, raw ceramic powders of Y₂O₃, Al₂O₃ and ZrO₂ are mixed together. These raw ceramic powders may have a purity of 99.9% or greater in one embodiment. The raw ceramic powders may be mixed using, for example, ball milling. The raw ceramic powders may have a powder size of in the range of between about 100 nm-20 μm. In one embodiment, the raw ceramic powders have a powder size of approximately 5 μm.

After the ceramic powders are mixed, they may be calcinated at a specified calcination time and temperature. In one embodiment, a calcination temperature of approximately 1200-1600° C. (e.g., 1400° C. in one embodiment) and a calcination time of approximately 2-5 hours (e.g., 3 hours in one embodiment) is used. The spray dried granular particle size for the mixed powder may have a size distribution of approximately 30 μm in one embodiment.

In one embodiment, the ceramic coating is produced from Y₂O₃ powder. The ceramic coating may also be produced from a combination of Y₂O₃ powder and Al₂O₃. Alternatively, the ceramic coating may be a high performance material (HPM) ceramic composite produced from a mixture of a Y₂O₃ powder, ZrO₂ powder and Al₂O₃ powder. In one embodiment, the HPM ceramic composite contains 77 wt % Y₂O₃, 15 wt % ZrO₂ and 8 wt % Al₂O₃. In another embodiment, the HPM ceramic composite contains 63 wt % Y₂O₃, 23 wt % ZrO₂ and 14 wt % Al₂O₃. In still another embodiment, the HPM ceramic composite contains 55 wt % Y₂O₃, 20 wt % ZrO₂ and 25 wt % Al₂O₃. Other distributions of these ceramic powders may also be used for the HPM material.

At block 404, optimal plasma spray parameters are selected. In one embodiment, optimizing plasma spray parameters includes, but is not limited to, setting a plasma gun power and a composition of spray carrier gas.

Optimizing the powder characteristics and the plasma spray parameters may lead to a coating with substantially fully melted nodules. For example, an increase in a plasma gun power together with a decrease in a powder feed rate ensures substantially complete melting of granulated powder. Complete or increased a melting decreases the porosity and increases a density of a ceramic coating. Such a decreased porosity and increased density improves protection of a coated article from corrosive elements such as plasmas. Also, fully melted nodules are less likely to break free of the ceramic coating and contaminate the wafer causing particle problems.

TABLE 1
Plasma Spray Input Parameters for Yttria Coating

| Input Parameter | Unit | POR | CIP#1 | CIP#2 | CIP#3 | CIP#4 |
|---|---|---|---|---|---|---|
| Power of Plasma | kW | 59 | 89 | 90 | 73 | 91 |
| Gun Current | A | 110 | 151 | 151 | 131 | 150 |
| Gun Voltage | V | 270 | 296 | 299 | 280 | 302 |
| Powder Feed | g/min. | 80 | 30 | 30 | 10 | 10 |
| Distance | mm | 80 | 80 | 80 | 80 | 100 |
| Gun Moving | mm/sec. | 650 | 650 | 500 | 500 | 500 |
| Speed | | | | | | |
| Gun Moving | mm | 4 | 4 | 2 | 2 | 2 |
| Pitch | | | | | | |
| Gun Angle | degrees | 90 | 90 | 90 | 90 | 90 |
| Gas Flow Rate | L/min. | 90 | 115 | 120 | 100 | 130 |

Table 1 illustrates input parameters for coating the article according to the process of FIG. 4A. The parameters include, but are not limited to, power of plasma, gun current, gun voltage, powder feed rate, gun stand-off distance, gun moving speed, gun moving pitch, gun angle, and gas flow rate. Table 1 illustrates how the parameters are modified over the generally accepted common parameters (titled “POR”) compared to different coatings using the new input parameters referred to as CIP1, CIP2, CIP3, and CIP4. FIGS. 5-12 illustrate the results of the coating using the different input parameters.

In one embodiment, plasma spray parameters include a plasma power, a gun current, a gun voltage, a distance from a substrate to a nozzle of the plasma sprayer, a movement speed of a plasma sprayer gun or nozzle, a motion pitch of the gun, an angle of the gun with relation to the substrate, and a gas flow rate. In one embodiment, optimal plasma spray parameters for plasma spraying a Y₂O₃ ceramic coating include a plasma power of about 90 kW, a gun current of approximately 150 A, a gun voltage of approximately 300V, a power feed rate of approximately 10 g/min, a distance of approximately 100 mm, a gun moving speed of approximately 500 mm/sec., a gun moving pitch of approximately 2 mm, a gun angle of about 45-90 degrees, and a gas flow rate of about 120-130 L/min.

At block 406, the article is coated according to the selected powder characteristics and plasma spray parameters. Plasma spraying techniques may melt materials (e.g., ceramic powders) and spray the melted materials onto the article using the selected parameters. Using such optimized plasma spraying parameters, a percentage of partially melted surface nodules may be reduced to about 0.5-15%.

In one embodiment, the plasma sprayed ceramic coating may have a thickness about 10-40 mil (e.g., 25 mil in one embodiment). The thickness, in one example, is selected according to an erosion rate of the ceramic coating to ensure that the article has a useful life of approximately 5000 Radio Frequency Hours (RFHrs). In other words, if the erosion rate of a particular ceramic coating is about 0.005 mil/hr, then for a useful life of about 5000 RFHrs, a ceramic coating having a thickness of about 25 mil may be formed.

The plasma spray process may be performed in multiple spray passes. As per the selected optimal plasma spray parameters, passes may have a gun or nozzle moving speed of approximately 500 mm/second. For each pass, the angle of a plasma spray nozzle may change to maintain a relative angle to a surface that is being sprayed. For example, the plasma spray nozzle may be rotated to maintain an angle of approximately 45 degrees to approximately 90 degrees with the surface of the article being sprayed. Each pass may deposit a thickness of up to approximately 100 μm. The plasma spray process may be performed using in the range of between about 30-45 passes (e.g., 35-40 passes in one embodiment).

The ceramic coating may have a porosity of approximately 0.5-5% (e.g., less than approximately 5% in one embodiment), a hardness of approximately 4-8 gigapascals (GPa) (e.g., greater than approximately 4 GPa in one embodiment), and a thermal shock resistance greater than of about 24 MPa. Additionally, the ceramic coating may have an adhesion strength of approximately 4-20 MPa (e.g., greater than approximately 14 MPa in one embodiment). Adhesion strength may be determined by applying a force (e.g., measured in megapascals) to the ceramic coating until the ceramic coating peels off from the ceramic substrate. Other properties of the plasma sprayed ceramic coating may include an HCl bubble time of greater than approximately 8 hours for an 8 mil this coating and a breakdown voltage of greater than about 700 V/mil.

TABLE 2
Plasma Spray Coating Enhancement Optimized Results

| | | | | | | | Optimized |
|---|---|---|---|---|---|---|---|
| Metric | Units | POR | CIP#1 | CIP#2 | CIP#3 | CIP#4 | Range |
| Partially Melted Surface | % | 30% | 15% | 10% | 7% | 7% | 5%-20% |
| Nodules | | | | | | | |
| Surface Roughness | μ- | 180 | 160 | 158 | 186 | 182 | 160-180 |
| | inch | | | | | | |
| Coating Porosity | % | 3% | 1.50% | 1.50% | ~1.2% | ~1 | 0%-2% |
| HCl Bubble Time | hr | 4 | >6 | >6 | >6 | >8 | >6 |
| Breakdown Voltage | V/mil | 630 | >700 | >700 | >700 | >700 | >700 |

Table 2 illustrates measured coating characteristics using the optimized plasma and powder parameters as described above in comparison to those used in standard practice (POR). In one embodiment, the optimized parameters reduce partially melted surface nodules from 30% of the POR samples to about 15%. Other improvements include a smoother surface, decreased porosity, greater resistance to erosion, and a higher breakdown voltage.

Table 2 illustrates characteristics of different coatings produced using the input parameters of Table 1. The samples POR, CIP1, CIP2, CIP3, and CIP4 correspond to the respective input parameters of Table 1. In the depicted embodiment, the percent of partially melted surface nodules significantly decreases from 30% of the POR to 7% of sample CIP4. Likewise, porosity improves (e.g., from about 3% down to about 1-1.5%), as well as HCl Bubble time (a measure of resistance to erosion), and breakdown voltage.

FIG. 5 is a pair of micrographs 502 and 504. Micrograph 502 shows a cross-section of a coating 512 plasma sprayed using optimized input parameters as described above. Micrograph 504 shows a cross-section of a coating 516 plasma sprayed using POR parameters. Micrograph 504 illustrates a partially melted nodule 508. Partially melted nodules 508 are problematic in that the partially melted nodule 508 has a tendency to break away from the coating 516 and contaminate the surface of a substrate in a plasma etch process.

Micrograph 502, conversely, illustrates a nodule 506 fully melted into the surface of the coating 512. The fully melted nodule 506 has a much lower probability of breaking away from the surface of the coating 512 to contaminate a substrate.

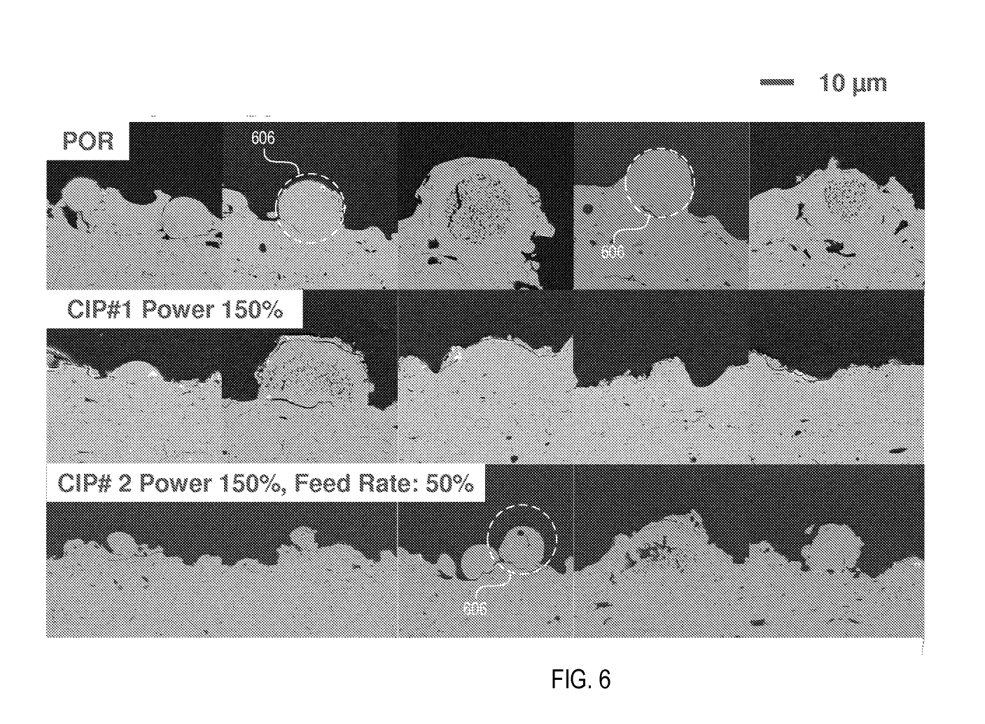

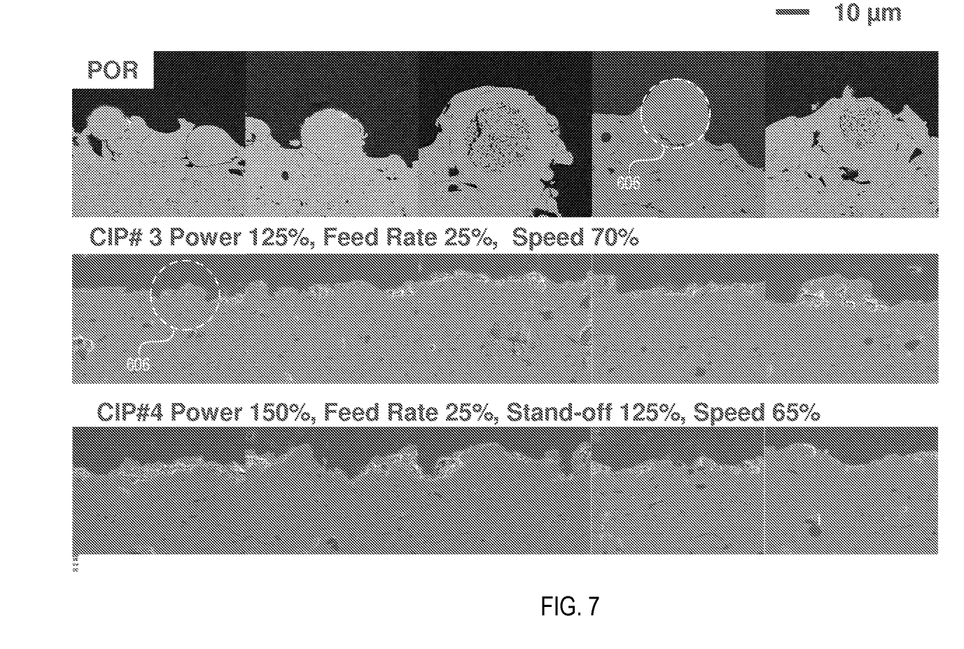

FIGS. 6 and 7 illustrate cross-sectional side views of ceramic coatings that have been created using various plasma spray parameters. Specifically, FIGS. 6 and 7 illustrate a reduction in surface nodules from the generally accepted parameters of the POR sample to the optimized parameters of CIP1-4. Of note, the frequency of nodules 606, density of nodules 606, and diameter of nodules 606 decreases from the POR sample to the CIP1, CIP2, CIP3, and CIP4 samples.

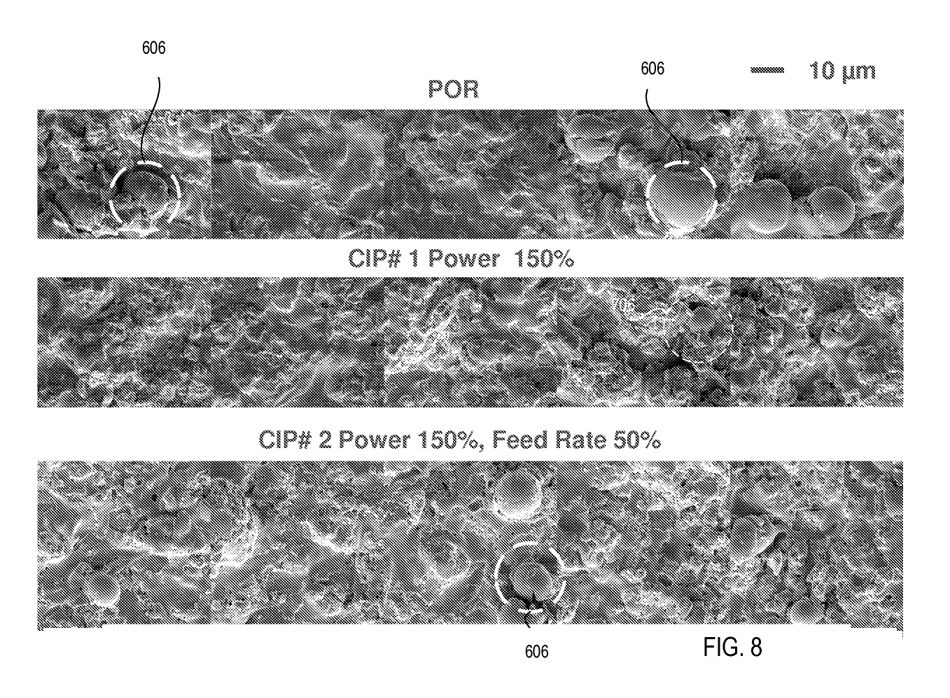

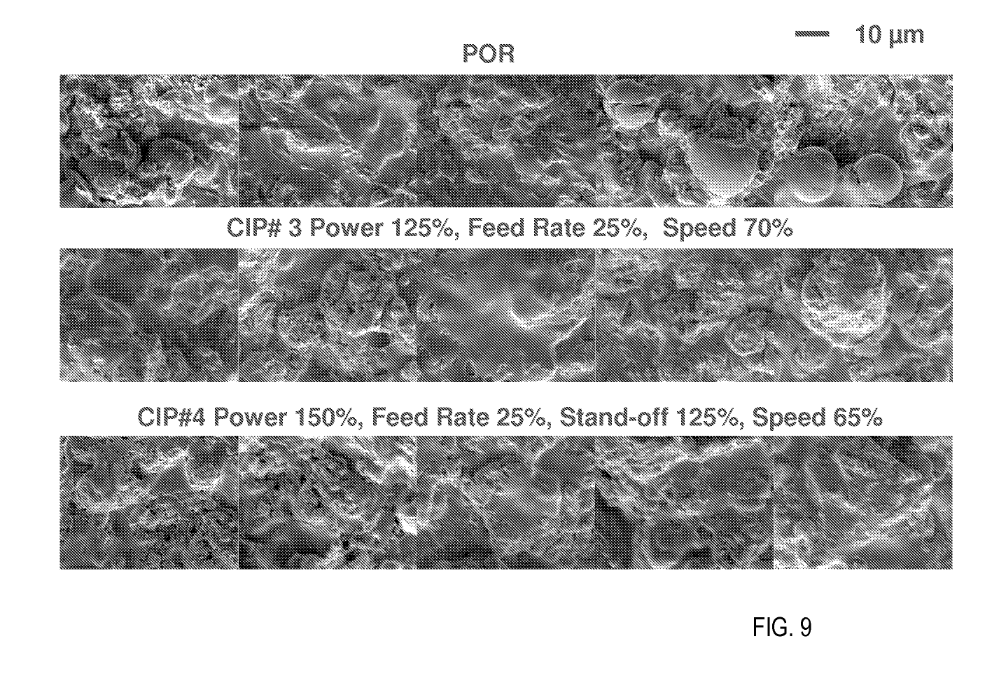

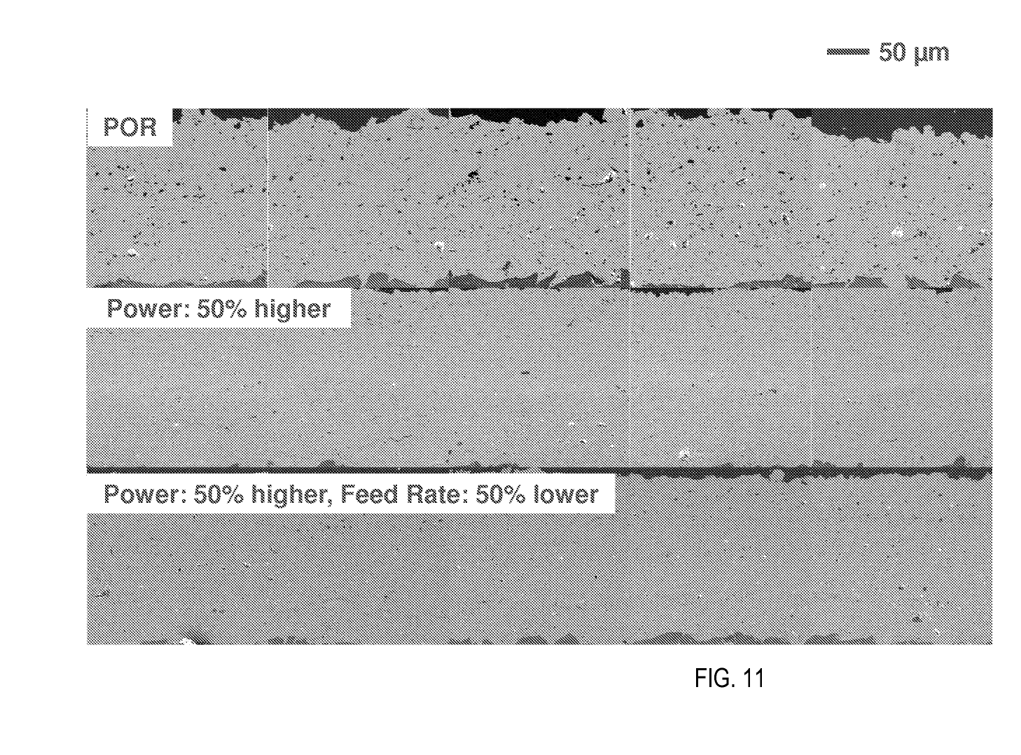

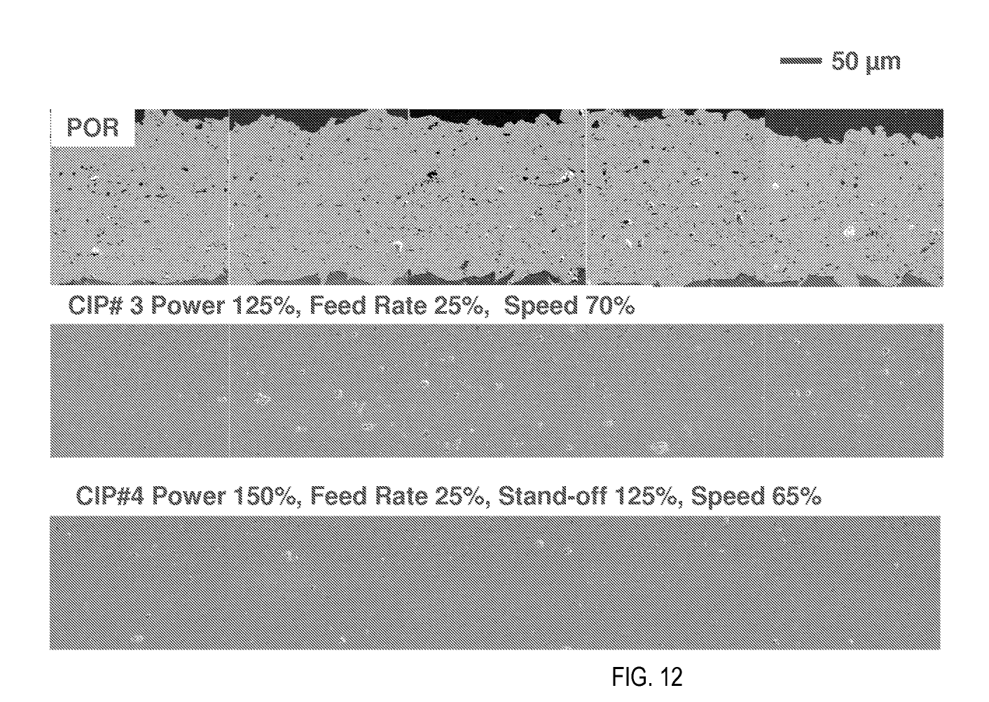

FIGS. 8 and 9 illustrate top view micrographs of the ceramic coating and the reduction of frequency, density, and size of nodules 606. Although not all nodules 606 are specifically identified in FIGS. 11 and 12, one of skill in the art will recognize that the nodule frequency, size, and density decreases between the POR sample and the CIP1-4 samples.

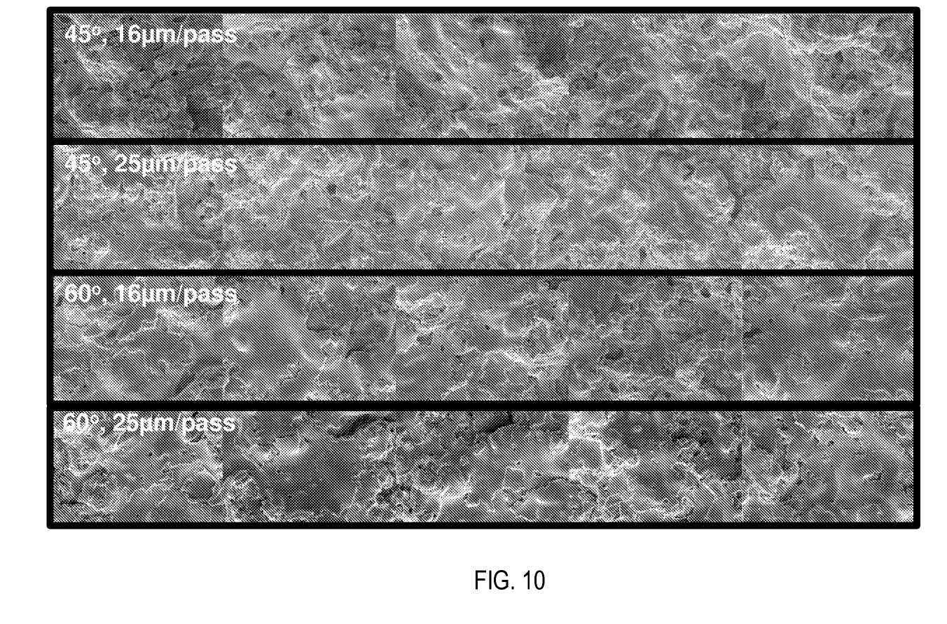

FIG. 10 illustrates micrographs of a top view of ceramic coatings using different coating angles and feed rates. The angles illustrated refer to the angle of the plasma gun with reference to the article. For reference, the plasma gun of FIG. 3 is at an angle of 90 degrees with reference to the article. As shown, lower feed rates produce greater surface uniformity.

FIGS. 11 and 12 illustrate cross-section micrographs of the ceramic coating using the input parameters from Table 1. These figures illustrate a decreased porosity using the optimized input parameters according to the settings of Table 1. Some factors that help improve the porosity include, but are not limited to, increasing the power of the plasma gun and/or decreasing the feed rate of the powder. A combination of both of those factors further improves upon the porosity. Stated differently, increasing the power by 50% over the POR input parameters and decreasing the feed rate of the powder by 50% noticeably decreases the porosity of the coating. Further improvements are realized by also increasing the stand-off distance and reducing the speed of the plasma gun for the POR input parameters.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
selecting a plasma power of between about 89-91 kW for a plasma spraying system;
flowing gas through the plasma spraying system at a selected gas flow rate of about 115-130 L/min;
feeding powder comprising a yttrium containing oxide into the plasma spraying system at a selected powder feed rate of about 10-30 g/min; and
forming a ceramic coating on a substrate based on the selected power, the selected gas flow rate and the selected powder feed rate.

2. The method of claim 1, further comprising:
setting a distance between a nozzle of the plasma spraying system and the substrate to about 100 mm.

3. The method of claim 1, further comprising:
setting a gun moving speed to about 500 mm/sec; and
setting a gun moving pitch to about 2 mm and a gun angle to about 45-90 degrees.

4. The method of claim 1, further comprising:
setting a gun current to about 130-150 A and a gun voltage to about 380-300 V.

5. The method of claim 1, wherein the ceramic coating has a percentage of partially melted surface nodules at about 7-17%.

6. The method of claim 1, wherein the ceramic coating has a porosity of less than about 1.5%.

7. The method of claim 1, wherein the ceramic coating has an HCl bubble time of greater than 6 hours.

8. The method of claim 1, wherein the ceramic coating has a breakdown voltage of about 700 V/mil.

9. The method of claim 1, wherein the ceramic coating is a yttria coating and the powder consists of yttria.

10. An article having a ceramic coating on at least one surface, wherein the coating having been applied by a process comprising:
selecting a plasma power of between about 89-91 kW for a plasma spraying system;
flowing gas through the plasma spraying system at a selected gas flow rate of about 115-130 L/min;
feeding powder comprising a yttrium containing oxide into the plasma spraying system at a selected powder feed rate of about 10-30 g/min; and
forming the ceramic coating on the at least one surface of the article based on the selected power, the selected gas flow rate and the selected powder feed rate.

11. The article of claim 10, the process further comprising:
setting a distance between a nozzle of the plasma spraying system and the substrate to about 100 mm.

12. The article of claim 10, the process further comprising:
setting a gun moving speed to about 500 mm/sec; and
setting a gun moving pitch to about 2 mm and a gun angle to about 45-60 degrees.

13. The article of claim 10, the process further comprising:
setting a gun current to about 130-150 A and a gun voltage to about 380-300 V.

14. The article of claim 10, wherein the ceramic coating has a percentage of partially melted surface nodules at about 7-17%.

15. The article of claim 10, wherein the ceramic coating has a porosity of less than about 1.5%.

16. The article of claim 10, wherein the ceramic coating has an HCl bubble time of greater than 6 hours.

17. The article of claim 10, wherein the ceramic coating has a breakdown voltage of about 700 V/mil.

18. The article of claim 10, wherein the ceramic coating is a yttria coating and the powder consists of yttria.

19. A method of plasma spraying a yttria ceramic coating onto a chamber component of a plasma etch reactor comprising:
selecting a plasma power of between about 89-91 kW for a plasma spraying system;
flowing gas through the plasma spraying system at a selected gas flow rate of about 115-130 L/min;
feeding a yttria powder into the plasma spraying system at a selected powder feed rate of about 10-30 g/min; and
forming a ceramic coating on a substrate based on the selected power, the selected gas flow rate and the selected powder feed rate.

20. The method of claim 19, wherein the yttria ceramic coating has a percentage of partially melted surface nodules at about 7-17%, a porosity of less than about 1.5%, and a breakdown voltage of about 700 V/mil.
